(19) United States
(12) Patent Application Publication
(10) Pub. No.: US 2026/0329400 A1
(43) Pub. Date: Oct. 22, 2026

(54) TOUCH-SENSOR CALIBRATION

(71) Applicant: Microsoft Technology Licensing, LLC, Redmond, WA (US)

(72) Inventors: Roei Shlomo MENASHOF, Netanya (IL); Oren ISTRIN, Tel Aviv (IL); Nadav LINENBERG, Even Yehuda (IL)

(73) Assignee: Microsoft Technology Licensing, LLC, Redmond, WA (US)

(21) Appl. No.: 19/184,625

(22) Filed: Apr. 21, 2025

(51) Int. Cl. G06F 3/041; G06F 3/044

(52) U.S. Cl. CPC G06F 3/0418; G06F 3/04166; G06F 3/0446

(57) ABSTRACT

A method for calibrated touch sensing on an electronic device comprises: (a) scanning driven electrodes of a touch sensor while recording signal from sensory electrodes of the touch sensor; (b) storing the signal in a signal matrix; (c) for each element in the signal matrix that is lower than a predetermined threshold, adjusting a corresponding element in the calibration matrix based at least partly on a value of the element in the signal matrix and on a value of the corresponding element in the calibration matrix; (d) for each element in the signal matrix that is above the predetermined threshold, estimating the corresponding element in the calibration matrix based at least partly on one or more elements neighboring the corresponding element in the calibration matrix; and (e) returning a calibrated signal value based at least partly on corresponding values in the signal and calibration matrices.

### BACKGROUND

A touch sensor is an input component of many different kinds of electronic devices. In some examples, a touch sensor comprises optically transparent material layered above or integrated within a display panel of an electronic device—a configuration offering combined touch-sensing and display functionality.

### SUMMARY

One aspect of this disclosure relates to a method for calibrated touch sensing on an electronic device. The method comprises: (a) scanning a series of driven electrodes of a touch sensor while recording signal from a series of sensory electrodes of the touch sensor; (b) storing the signal in a signal matrix having a row corresponding to each row of a calibration matrix and a column corresponding to each column of the calibration matrix; (c) for each element in the signal matrix that is lower than a predetermined threshold, adjusting a corresponding element in the calibration matrix based at least partly on a value of the element in the signal matrix and on a value of the corresponding element in the calibration matrix; (d) for each element in the signal matrix that is above the predetermined threshold, estimating the corresponding element in the calibration matrix based at least partly on one or more elements neighboring the corresponding element in the calibration matrix; and (e) returning a calibrated signal value based at least partly on the value of an element in the signal matrix and of a corresponding element in the calibration matrix.

Another aspect of this disclosure relates to an electronic device comprising a touch sensor. The touch sensor has a series of driven electrodes, a series of sensory electrodes, and a digitizer. The digitizer is configured to enact the method summarized above.

This Summary is provided to introduce in simplified form a selection of concepts that are further described in the Detailed Description. This Summary is not intended to identify key features or essential features of the claimed subject matter, nor is it intended to be used to limit the scope of the claimed subject matter. The claimed subject matter is not limited to implementations that solve any disadvantages noted in any part of this disclosure.

### BRIEF DESCRIPTION OF THE DRAWINGS

FIG. 1 shows aspects of an example electronic device having a touch sensor.

FIG. 2 shows aspects of an example capacitive touch sensor.

FIG. 3 shows aspects of an example electronic device having a touch sensor and digitizer.

FIG. 4 shows aspects of an example method for calibrated touch sensing on an electronic device.

FIG. 5 shows aspects of an example calibration matrix C and signal matrix H, which are relevant to the method of FIG. 4.

FIG. 6 shows aspects of a fully convolutional neural network (CNN) in one example.

FIG. 7 shows aspects of an example computer system.

### DETAILED DESCRIPTION

In order to maintain performance, a touch sensor of an electronic device may support one or more calibration procedures. This disclosure presents a method for continuous calibration of a capacitive touch sensor. The method addresses certain limitations of existing calibration methods, such as on-the-fly (OTF) recalibration. Enacted when it is assumed that the user is providing no touch input, OTF recalibration may exhibit significant calibration latency, as well as sensitivity to noise and unintentional contact during the recalibration scan. In particular, as the calibration matrix recorded via OTF recalibration is static over the interval between successive recalibration scans, OTF recalibration cannot correct for continuously varying noise. OTF recalibration also may fail in scenarios in which noise or user contact are substantially uninterrupted.

By contrast, the method here disclosed scans continuously the row-column loci of the touch sensor. Signal values that fall below a predetermined threshold are used to incrementally update the calibration matrix. Any locus at which the signal value exceeds a predetermined threshold is classified as potential noise or touch and does not contribute to the incremental update. Rather, the elements of the calibration matrix at these loci are estimated based on the values of neighboring loci where the signal value falls below the predetermined threshold. In some scenarios, the evolving calibration matrix may reveal a spatial and/or temporal pattern—e.g., excess systematic noise at certain times or in certain areas of the touch sensor—which can be further remedied. In some examples, a neural network or other machine-learning model can be used to enact the above classification or estimation, and/or return the calibrated signal. With appropriate training, a machine-learning model can be made responsive to the conditions that cause the excess noise and thereby provide superior noise immunity—i.e., dynamically changing the classification and/or calibration formulae. This feature can be used to sharpen touch-input accuracy in various touch-sensor devices and improve the user experience. Leveraging the advantage of continuous calibration, the solutions herein de-emphasize the need for factory calibration, potentially freeing up valuable flash memory that would otherwise be reserved for storage of a factory-calibration matrix.

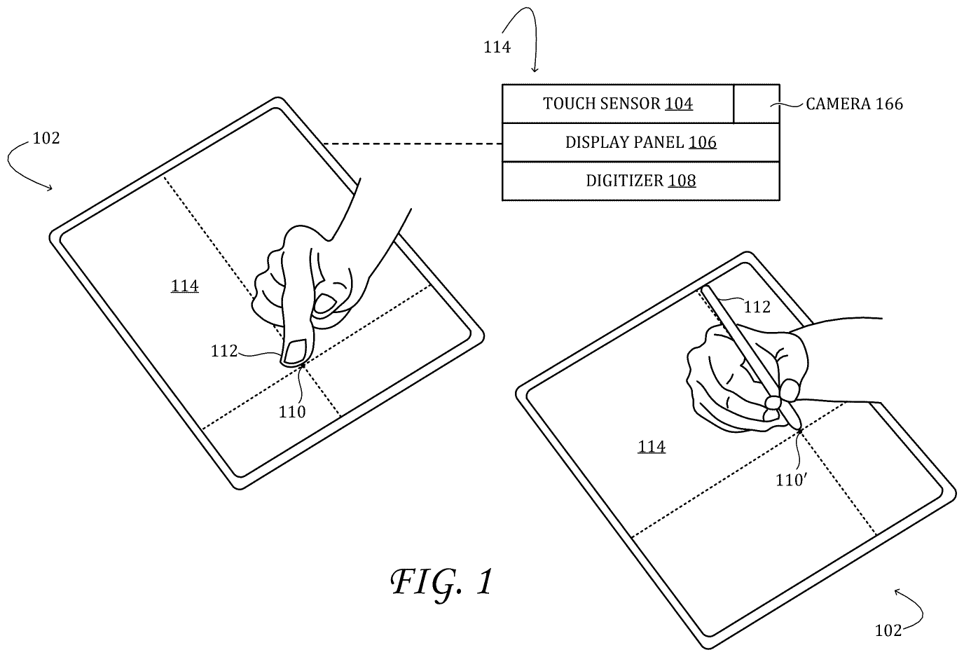

Turning now to the drawings, FIG. 1 shows aspects of an example electronic device 102 in the form of a tablet computer system. In other examples, the electronic device may take the form of a laptop computer system, a smartphone, a handheld game system, a medical device, an information kiosk, or virtually any other kind of electronic device. The electronic device includes a touch sensor 104, which is configured to provide input to the electronic device. Display panel 106 and digitizer 108 are set behind the touch sensor. Coupled electronically to the touch sensor, the digitizer is an electronic circuit configured to interrogate, and receive data from, the touch sensor. Display panel 106 may comprise liquid-crystal display (LCD) or organic light-emitting diode (OLED) componentry in some examples. More generally, an electronic device may employ any kind of display technology, or none at all.

The illustrated touch sensor 104 is configured to sense at least one touch point 110 effected by the user of electronic device 102. An example touch point is the point of contact between the user's fingertip 112 and sensory surface 114 of the touch sensor. As noted hereinafter, touch sensor 104 may also be configured to sense the point of contact 110′ of an input device, such as touch-screen stylus 112, on the sensory surface.

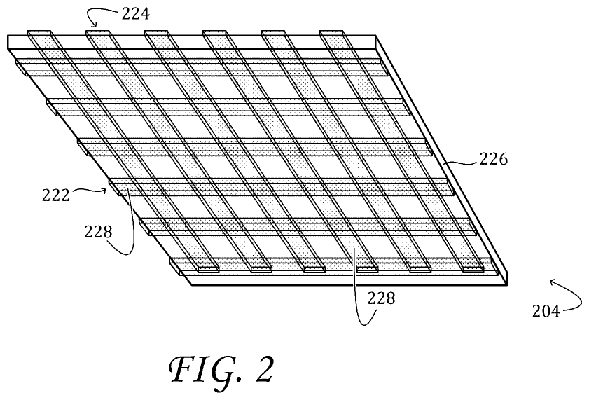

FIG. 2 shows additional aspects of an example capacitive touch sensor 204 in expanded detail. The capacitive touch sensor comprises a series of row electrodes 222 that cross a series of column electrodes 224. Touch sensors here contemplated may include any number N of row electrodes and any number M of column electrodes. Although it is customary to have the row electrodes aligned horizontally and the column electrodes aligned vertically, that aspect is in no way necessary, as the terms ‘row’ and ‘column’ may be exchanged everywhere in this description. In the illustrated example, the series of row electrodes 222 is arranged on one face of a dielectric layer 226, and the series of column electrodes 224 is arranged on the opposite face of the dielectric layer. The dielectric layer may be 50 to 100 μm in some examples, while other thickness ranges are also envisaged. The dielectric layer may comprise a polymer film, such as polyethylene terephthalate (PET). In curved, flexible and/or bendable electronic devices, the dielectric layer may be curved, flexible and/or bendable.

Row electrodes 222 and column electrodes 224 each comprise electronically conductive material 228 distributed in the form of narrow (e.g., one mm-wide), elongate bands on the opposite faces of dielectric layer 226. Adjacent electrodes may be separated by one to five millimeters in some examples. The composition of electronically conductive material 228 is not particularly limited. The electronically conductive material may comprise a metallic microwire mesh, a metal-particle or metal-island film, or a film of a degenerately doped semiconductor, such as indium-tin oxide (ITO), for instance.

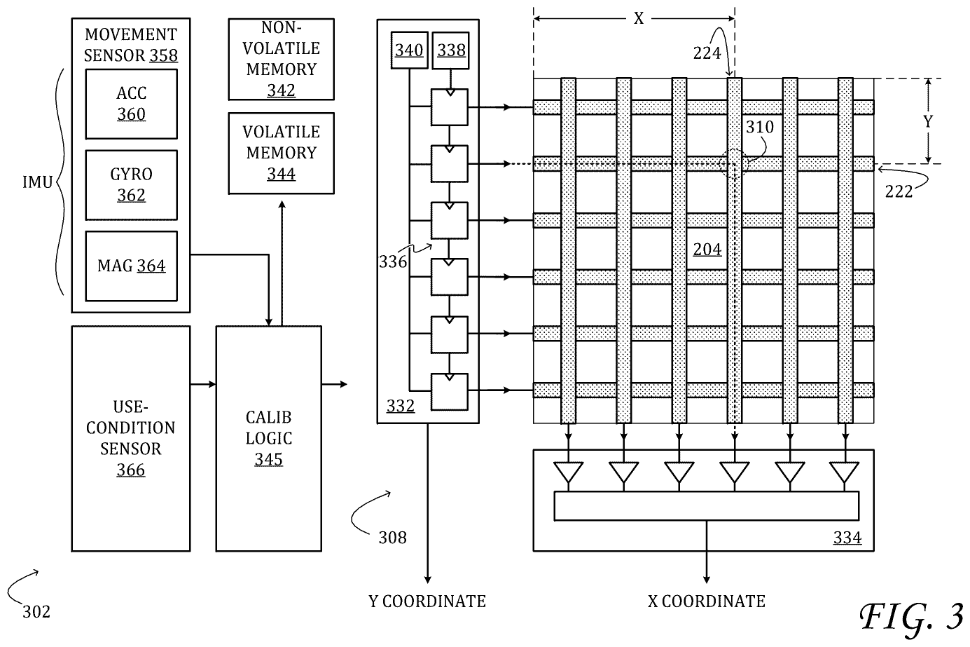

FIG. 3 shows aspects of an example electronic device 302, including capacitive touch sensor 204 and digitizer 308. In the illustrated example, row electrodes 222 and column electrodes 224 of the capacitive touch sensor are addressed by the digitizer. The digitizer is configured to sense contact on or near the sensory surface of the touch-screen display device, including coordinates (X, Y) directly beneath the point of contact 310 of a finger or touch-screen stylus. To that end, the digitizer includes row-drive circuit 332 and column-sense circuit 334. The terms ‘row-drive’ and ‘column-sense’ are appropriate for configurations in which drive signal is driven through the row electrodes and sensed via the column electrodes. Naturally, the opposite configuration is also envisaged.

Column-sense circuit 334 is configured to sense column signal from the series of column electrodes 224. In the illustrated example, the column-sense circuit includes M column amplifiers, each coupled to a corresponding column electrode. Row-drive circuit 332 includes a local row counter 336 in the form of an N-bit shift register with outputs driving each of the N row electrodes 222. The local row counter is clocked by row-driver clock 338. The local row counter includes a blanking input to temporarily force all output values to zero irrespective of the values stored within the shift-register. Excitation of one or more rows may be provided by filling the local row counter with ones at every output to be excited, and zeroes elsewhere, and then toggling the blanking signal with the desired modulation from modulation clock 340. In the illustrated example, the output voltage may take on only two values, corresponding to the one or zero held in each bit of the local row counter. In other examples, the output voltage may take on a greater range of values, to reduce the harmonic content of the output waveforms or decrease radiated emissions, for instance. In some examples, row-drive circuit 332 may include one or more additional registers offset with respect to local row counter 336 and blanked by modulation clocks of different frequencies. Such variants enable concurrent excitation of two or more row electrodes (e.g., electrodes separated by a fixed number of intervening rows).

Row-drive circuit 332 of FIG. 3 applies an excitation pulse to each row electrode 222 in sequence. In this manner, the row-drive circuit is configured to concurrently drive one or more row electrodes of the series of row electrodes while leaving undriven one or more other row electrodes of the series of row electrodes. During a period in which the sensory surface is untouched, none of the column amplifiers registers an above-threshold output. However, the electrical impedance at each crossing of a row electrode 222 and a column electrode 224 is responsive to the proximity of a finger or stylus to that crossing: when the user places a fingertip on the sensory surface, the fingertip capacitively couples one or more row electrodes 222 proximate to (e.g., crossing) touch point 310 to one or more column electrodes 224 also proximate to the touch point. The capacitive coupling induces an above-threshold signal from the column amplifiers associated with the column electrodes behind the touch point.

Column-sense circuit 334 may return a plurality of numeric signal values, which report on the X coordinate of the touch point. Digitizer 308 determines which row was being excited when the plurality of numeric signals are received and returns the numeric value of that row as the Y coordinate of the touch point. In some examples, column-sense circuit 334 may also return a Z coordinate that varies in dependence on the strength of the signal received at coordinates (X, Y). Accordingly, digitizer 308 may distinguish firm touch, associated with strong signal, from light touch, associated with weaker signal, and from hover, associated with still weaker but detectable signal.

Despite the utility of capacitive touch sensing as outlined above, the signal-to-noise ratio for touch-point sensing is affected by baseline coupling between pairs of row and column electrodes, which persists even when the crossing between the electrodes is untouched. Such coupling may be due to dielectric layer 226 itself or to the common electrode of a display panel, and/or other components of electronic device 302. Generally speaking, the magnitude of the baseline coupling may vary from one electrode crossing to another in the same touch sensor. Inevitable tolerances in the manufacture of an electronic device make accurate prediction of the baseline coupling very difficult.

To enable correction of the column signal for the effect of the baseline coupling (‘baseline correction’ herein), factory calibration of a touch sensor optionally can be enacted during manufacture of the electronic device in which the touch sensor is installed. In factory calibration, while the touch sensor is untouched, excitation signal is applied to each row electrode 222 in sequence, and the column signal from each amplifier of column-sense circuit 334 is recorded. Based on the series of column signals recorded in this manner, each of a plurality of (X, Y) coordinates of the touch sensor is mapped to a corresponding touch-free capacitance. The term ‘touch-free capacitance’ refers herein to the capacitance between a given pair of row and column electrodes in the absence of user touch. When factory calibration is enacted, the resulting factory calibration matrix is saved in non-volatile memory 342 of the electronic device—e.g., flash memory. In some examples the factory-calibration process is repeated at each of the excitation frequencies used in normal operation by row-drive circuit 332. After the factory calibration, and when the electronic device is in use, the factory calibration matrix is retrieved from the non-volatile memory and used to correct the column signal from column-sense circuit, thereby reducing or eliminating the effect of the baseline coupling on the column signal and improving the signal-to-noise ratio for touch-point detection.

The terms ‘mapping’ and ‘mapped to a corresponding touch-free capacitance’ should be interpreted broadly in this disclosure. In some examples a calibration matrix is a structure wherein a corresponding numeric value is stored for each crossing (i, j) of row and column electrodes, where i ranges from 1 to N and j ranges from 1 to M. In some examples, plural numeric values corresponding to different excitation frequencies may be stored for each crossing of row and column electrodes. In some examples the numeric value or values stored may be proportional to the touch-free capacitances measured at the crossing. In other examples, a surrogate metric proportional to the touch-free admittance or impedance may be stored. In still other examples, the touch-free capacitance, admittance, or impedance may be transformed mathematically to improve storage efficiency and/or subsequent processing efficiency (when used for correction of the column signals). In still other examples, the calibration matrix may not comprise discrete numeric values corresponding to every electrode crossing but may comprise an aggregate representation, such as the coefficients of a polynomial or Fourier series fit to a touch-free capacitance, admittance, or impedance measurement. In the spirit of these and all other suitable variants, each of a plurality of (X, Y) coordinates of the touch sensor is mapped, directly or indirectly, to a corresponding touch-free capacitance.

Factory calibration enables correction for built-in variability of the baseline coupling but not for variability due to device damage and/or ageing or to the operating environment of an electronic device. Environmental factors liable to affect the baseline coupling include condensing atmospheric humidity, perspiration and oil from the user's hand, dirt deposited on the sensory surface, and ambient electromagnetic noise. In order to correct for post-manufacturing variability in the baseline coupling, a touch sensor may be recalibrated at suitable intervals during its lifetime. Recalibration may follow the same procedure described above with respect to factory calibration. The resulting calibration matrix is saved in volatile memory 344, however (e.g., random-access memory), and may be overwritten each time the recalibration is successful. Thus, successful recalibration comprises replacement of a stored mapping of each of a plurality of (X, Y) coordinates of the touch sensor to a corresponding touch-free capacitance. In the interval between successful recalibrations, the calibration matrix can be used to correct the column signal for the effects of baseline coupling.

A significant operational difference between factory calibration and recalibration is that conditions during recalibration cannot be controlled as they are in the factory. At a minimum it is desirable to ensure that no finger or touch-screen stylus is in contact with the sensory surface during the recalibration. It also may be desirable to ensure that the electronic device is not in the user's hand, or even that there is no nearby person liable to handle the electronic device during the recalibration. In some examples a provisional calibration matrix is acquired in the manner above, saved in volatile memory 344, and then tested to rule out user contact with the touch sensor. Each time a provisional calibration matrix passes the test, that mapping is committed for use in subsequent baseline correction—i.e., the touch sensor has now been ‘recalibrated’. A provisional calibration mapping that fails the test can be ignored until the next update. Typically a provisional calibration matrix passes the test if it sufficiently resembles an expected calibration matrix. A disadvantage of that approach is that it may erroneously suppress recalibration in corner cases, where the sensor is untouched but the provisional calibration matrix deviates significantly from the expected due to unpredictable conditions—device damage and/or ageing, condensing humidity, dirt, electromagnetic noise, etc.

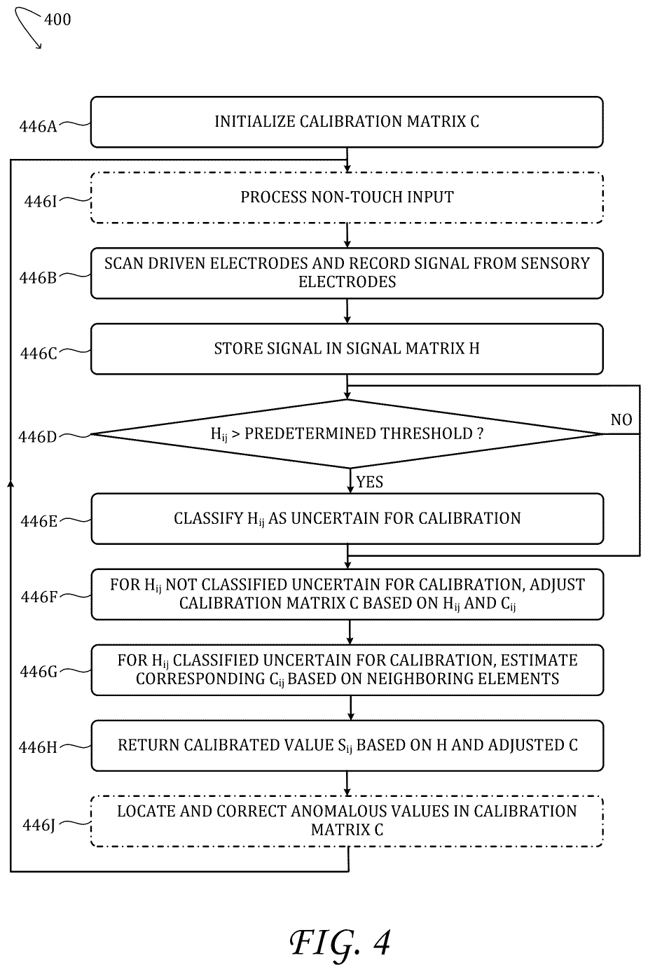

The balance of this disclosure addresses the foregoing issues and provides further advantages. Returning now to the drawings, FIG. 4 shows aspects of an example method 400 for calibrated touch sensing on an electronic device. The illustrated method scans continuously the row-column loci of the touch sensor. Signal values that fall below a predetermined threshold are used to incrementally update the calibration matrix. Any locus at which the signal value exceeds the predetermined threshold is classified as potential noise or touch and does not contribute to the incremental update. Rather, the elements of the calibration matrix at these loci are estimated based on neighboring loci where the signal values fall below the predetermined threshold. Method 400 may be enacted in calibration logic 345 of electronic device 302 or in any other suitable logic.

At 446A of method 400, the calibration logic initializes a calibration matrix C. The calibration matrix C is a digital data structure as described hereinabove. In some examples, the calibration matrix C has as many rows as there are driven electrodes of the touch sensor and as many columns as there are sensory electrodes of the touch sensor. In some examples, the initialization step loads a zero in every element of the calibration matrix C. In some examples, the initialization step copies over a factory calibration matrix from non-volatile memory to volatile memory of the electronic device.

At 446B, the digitizer scans the series of driven electrodes (e.g., row electrodes) of the touch sensor while recording signal from the series of sensory electrodes (e.g., column electrodes) of the touch sensor.

At 446C, the calibration logic stores the recorded signal in a signal matrix H, which also may be called a ‘heat map’. In some examples, the signal matrix H has a row corresponding to each row of calibration matrix C and a column corresponding to each column of calibration matrix C.

At 446D, each element Hᵢⱼ of signal matrix H is compared against a predetermined threshold Cᵢⱼ+δ_{N}, where Cᵢⱼ is the value of the corresponding element of the calibration matrix. In some examples δ_{N} is a constant parameter value, which may be positive or negative. The result of the comparison can be registered in various ways by the calibration logic of the digitizer. In one example, the calibration logic may apply a classification to each element Hᵢⱼ of the signal matrix H. At 446E calibration logic may assign an ‘uncertain’ classification (e.g., +1) to each element having a signal value greater than Cᵢⱼ+δ_{N}. Such values may arise due to excessive noise or to actual touch. Such values are unusable, therefore, for the purpose of updating calibration matrix C. Optionally, at 446E, the calibration logic may assign a ‘low-noise, touch-free’ classification (e.g., −1) to each element having a value less than Cᵢⱼ+δ_{N}, such values corresponding to a low-noise, touch-free condition. By this or any other suitable mechanism, an uncertainty classification (e.g., +1) is attached to each element in the signal matrix H having a value that exceeds the predetermined threshold.

Classification, at 446E, of each element of the signal matrix provides the core technical effect of allowing each and every scan of the touch sensor to serve double duty: some of the data from each scan may be used to refine the calibration matrix C, and the rest of the data may be used to reveal purposeful touch input (if any) from the user. In method 400, the classification provides the discriminant. Accordingly, there is no need for intermittent recalibration scans, which can be challenging to schedule due to the unpredictable behavior of the user. Another technical effect of the classification is that the touch sensor can be maintained in substantially continuous calibration, as opposed to the intermittent calibration resulting from OTF calibration.

For each element Hᵢⱼ in the signal matrix H that is lower than the predetermined threshold Cᵢⱼ+δ_{N} (not classified uncertain), the calibration logic, at 446F, adjusts the corresponding element Cᵢⱼ in the calibration matrix C based at least partly on the value of Hᵢⱼ and on the value of the corresponding element Cᵢⱼ (before adjustment). In some examples, the act of adjusting the corresponding element Cᵢⱼ comprises replacing the value of Cᵢⱼ by the value A×Cᵢⱼ+(1−A)×Hᵢⱼ, where A is a predetermined parameter value between 0 and 1. Formulae of this kind, which do not erase the pre-existing calibration data but gradually fold in new data from the current scan, provide the technical benefit of maintaining overall continuity in the calibration matrix, avoiding abrupt changes that may be noticeable to the user.

More sophisticated modes of adjustment are also envisaged. In some examples the adjusting enacted at 446F comprises application of a neural network or other machine-learning model. In some examples, accordingly, supervised learning may be used to increase the calibration accuracy. For instance, a machine-learning model may be trained to map co-ordinate elements Hᵢⱼ and the current Cᵢⱼ to the subsequent Cᵢⱼ by processing training data comprising benchmark Hᵢⱼ and Cᵢⱼ and corresponding, ground-truth Sᵢⱼ. Regression models can be used to predict the relationship between the input touch data in H and the desired calibration values in C. Use of a machine-learning model provides the additional technical effect of more accurate accumulation of the calibration matrix C in cases where no simple, linear relation can accurately represent the combination of noise sources—e.g., sources that may combine out-of-phase. Neural networks can be particularly effective at handling complex patterns and non-linear relationships in the data. By training a neural network on historical touch data, the system can be trained to better predict and correct inaccuracies. As more data is collected and the model is trained over time, the accuracy of the calibration process improves. Relevant aspects of an example machine-learning model is described hereinafter.

For each element Hᵢⱼ in the signal matrix H that is above the predetermined threshold Cᵢⱼ+δ_{N} (classified uncertain), the calibration logic, at 446G, estimates the corresponding element in the calibration matrix based at least partly on one or more elements neighboring the corresponding element Cᵢⱼ in the calibration matrix C. Generally speaking, the one or elements neighboring Hᵢⱼ are elements to which the uncertainty classification (e.g., +1) is not attached. One technical effect of the use of neighboring elements is that an appropriate calibration value Cᵢⱼ is made available for each and every element. In other words, there will be no ‘holes’ in the calibration matrix, which could otherwise cause a spatially discontinuous touch output and degrade the user experience.

In some examples, estimating the corresponding element based at least partly on the one or more elements neighboring Cᵢⱼ in the calibration matrix C comprises interpolation and/or extrapolation. In some examples, estimating the corresponding element based at least partly on the one or more elements neighboring Cᵢⱼ in the calibration matrix C comprises a model-fitting procedure, such as a two-dimensional polynomial- or Gaussian-fitting procedure. Interpolation, extrapolation, and closed-form model fitting provide the technical effects of efficient computation for reduced touch-sensor latency.

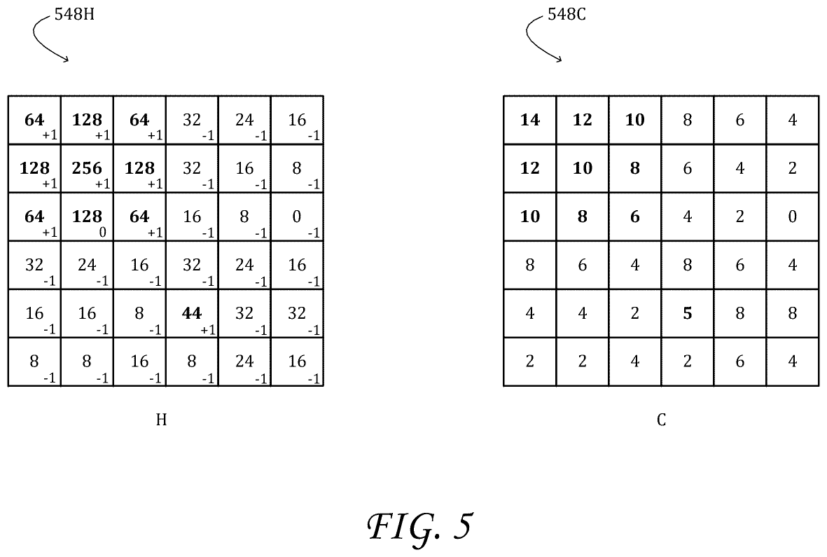

FIG. 5 shows aspects of an example signal matrix 548H and corresponding calibration matrix 548C. The elements of the illustrated matrices are labeled by value, and the signal matrix is labeled also by classification: +1 for the uncertain classification, and −1 for the low-noise, touch-free classification.

The gradation of signal values of signal matrix 548H is consistent with finger touch centered on the second row and second column (2, 2) of the touch sensor with excessive noise appearing at (5, 4). In the illustrated scenario, the predetermined threshold is 40, which results in the classifications shown. In order to show the effect of these values and classifications on calibration map 548C, the state of the calibration map prior to the current scan (of 548H) must be given. For ease of illustration, it will be assumed that all elements of the calibration map were initialized to zero just before the scan. It will be assumed also that the value of A in the formula given above is 0.25. Application of the formula will then yield the updated values shown in normal typeface in the cells of calibration map 548C.

In the illustrated scenario, the values of the uncertain elements of signal matrix 548H, shown in bold typeface, are not used in the update of calibration matrix 548C. Instead, such values are estimated via linear interpolation based on neighboring elements classified low-noise and touch-free. In a scenario in which an element with uncertain classification is located at the periphery of the touch sensor, linear extrapolation based on the interior elements could be used instead. As noted hereinabove, 2D polynomial or Gaussian fitting may also be used to estimate the value of an uncertain element used for calibration, again based on touch-free neighboring elements. In still other examples, a machine-learning model may be used to enact the estimation. In these and other variants, the calibration map, having been updated in part by direct adjustment and in part with reference to neighboring elements, may be used as a basis for extracting calibrated signal from signal map 548H, and the updated calibration matrix also becomes the basis for the subsequent update. In this manner, calibrated signal values may be returned to the OS for elements of any classification.

Returning now to FIG. 4, in examples in which the adjusting, estimating, and/or returning steps of method 400 are enacted via a machine-learning model, the model may process additional input besides co-ordinate elements Hᵢⱼ and Cᵢⱼ, both in training and in execution. At optional step 446I, for instance, the machine-learning model may process non-touch sensor data harvested from any component of the electronic device. The non-touch sensor data may comprise environmental-sensor output and user-interaction data furnished by the OS, for instance. Such data may be copied to the input layer of the machine-learning model and may thereby influence the adjusting, estimating and/or returning steps of method 400. Extension of the machine-learning model to include non-touch sensor data provides the technical effect of improved responsiveness to diverse environmental and use conditions, for improved touch-sensor accuracy. As described in greater detail hereinafter, such data may include output from a temperature sensor, a movement sensor, a camera, and/or other components of the electronic device.

As shown in the drawing, the features of method 400 downstream of initialization step 446A are enacted in a continuous loop. As noted hereinabove, the loop structure, which enables adjustment of the calibration matrix C each time the touch sensor is scanned. This feature provides the important technical effects of avoiding lapses in calibration due to the difficulty of recalibration scheduling, thereby improving touch-sensor accuracy.

Continuing in FIG. 4, the calibration logic returns, at 446H, a calibrated signal value Sᵢⱼ, based at least partly on the value of an element Hᵢⱼ in the signal matrix H and of the corresponding element Cᵢⱼ in the calibration matrix C. In some examples, the calibrated signal value Sᵢⱼ is returned to the OS of the electronic device. In some examples Sᵢⱼ=Hᵢⱼ−Cᵢⱼ; it will be understood, however, that more complex calibration formulae are also envisaged. For instance, signal calibration may be enacted via the machine-learning model introduced hereinabove. In some examples, the machine-learning model may be trained to map co-ordinate elements Hᵢⱼ and Cᵢⱼ to a calibrated signal value Sᵢⱼ by processing training data comprising benchmark Hᵢⱼ and Cᵢⱼ values and corresponding, ground-truth values Sᵢⱼ. This additional use of the machine-learning model provides the additional technical effect of more accurate calibration in cases in which a simple linear relation does not accurately reflect the relationship between Cᵢⱼ, Hᵢⱼ, and Sᵢⱼ. Use of the ground-truth values for training increases the efficiency (and decreases the required computational effort) for training the machine-learning model.

In some examples, method 400 includes the optional step 446J of locating and correcting an anomalous value of one or more elements in the calibration matrix C. Outside of the main loop of method 400, the calibration matrix C may be periodically reviewed. At regular intervals, the calibration data accumulated therein is analyzed to identify anomalies (e.g., systematic noise) that may develop during operation of the touch sensor. During the periodic review process, the calibration logic may seek to identify spatially and/or temporally recurring patterns of noise, or other trends that are inconsistent with the touch-sensor architecture. The calibration logic may detect, for instance, that calibrated touch points in certain areas of the touch sensor deviate from basic heuristic of user interaction—e.g., many touch points may be detected in the empty space between adjacent UI elements. Based on the identified anomalies, the calibration logic may adjust the values of the elements of the calibration matrix.

Over time, certain areas of the touch sensor may show slight deviations due to wear and tear or environmental factors. By implementing the retrospective learning at 446J, the calibration logic identifies these deviations, and adjusts the calibration values accordingly. In this manner, issues such as calibration-matrix ageing and anomalous edge effects may be addressed. Machine-learning models, such as regression models or neural networks, may be trained on historical touch data to predict and correct these inaccuracies. As a result, the touch screen maintains high accuracy and reliability.

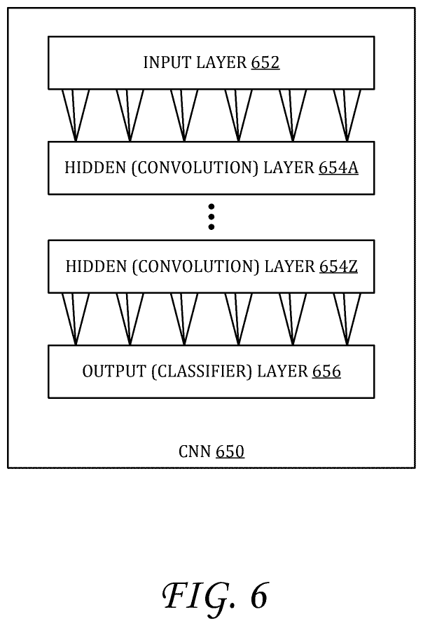

In one example, machine-learning model referenced above may take the form of a fully convolutional neural network (CNN) 650, as shown in FIG. 6. CNN 650 includes an input layer 652, a series of hidden layers 654, and an output layer 656. Each layer of the CNN includes an array of logic constructs called ‘neurons’. Each neuron of the input layer may correspond to coordinates (i, j) of a signal matrix H provided as input. During operation of the CNN, each element Hᵢⱼ of the signal matrix is received at the node corresponding to coordinates (i, j) of input layer 652 and is transformed successively through each of the series of hidden layers 654. Each neuron of a hidden layer receives its input from neurons of the layer above, enacts a logic operation on the input, and passes an output to neurons of the layer below. Each neuron of output layer 656 corresponds to a corrected signal value Sᵢⱼ attached to coordinates (i, j).

In contrast to the neurons of a generic neural network, each neuron of CNN 650 receives input only from the neuron directly above it, or from a close neighbor of that neuron. This feature reflects the fact that the corrected signal value Hᵢⱼ for coordinates (i, j) of the signal matrix H depends more strongly on information close to (i, j) than on information from distant parts of the signal matrix.

Among the hidden layers 654 of CNN 650 are one or more convolution, or filter, layers. Each convolution layer enacts a filtering operation by computing a dot product between its vector of inputs and a filter vector of the same dimensions. The elements of each filter vector are adjustable parameters called ‘filter weights’. During training of the CNN, the filter weights are optimized in a closed-loop manner, so as to cause the CNN to converge onto independently supplied, ground-truth (i.e., uncorrupted) matrices based on one or more corresponding, corrupted training matrices provided as input. In some examples, a global error is computed for the set of training matrices based on a trial set of filter weights, by comparing each output to the corresponding ground-truth matrix. Then each filter weight is adjusted so as to reduce the global error according to a back-propagation method. To facilitate back propagation, the filtering and/or other logic function enacted by each neuron may be required to be differentiable with respect to an associated filter weight. In some examples, each neuron may include logic configured to compute its own derivatives. Such derivatives may be used in a parameter optimization procedure, such as the ‘steepest descent’ method, among others.

CNN 650 may include a large number of filters arranged in hidden layers 654. In contrast to a generic neural network, where the filter vectors of each neuron are optimized independently, the filter vectors in CNN 650 may be constrained to reflect the inherent similarities among the individual elements of the signal matrix H. Provided that a sufficient quantity of training data is made available during the training phase, a CNN can potentially learn to properly correct for the corrupting influence of the various noise sources. Moreover, CNNs are naturally invariant to translational shifting in the component matrices at the input layer, providing tolerance to variances and offsets among the various component matrices (training and operational).

Some of the non-touch sensor data usable in method 400 will now be described, by way of example. Returning briefly to FIG. 3, electronic device 302 includes a movement sensor 358 having an output that varies in dependence on movement of the electronic device. Such movement may include translational movement and/or rotational movement. In some examples, the output of the movement sensor may be a binary output—viz., the movement of the electronic device does or does not exceed a predetermined threshold. Thus, movement sensor 358 may sense the absence of movement, in some examples. In other examples the movement may be resolved into translational and rotational components and/or quantified. In the example of FIG. 3, movement sensor 358 includes an inertial measurement unit (IMU) comprising linear accelerometer 360, electronic gyroscope 362, and magnetometer 364. The linear accelerometer is configured to sense a linear acceleration vector—e.g., linear acceleration along three, mutually orthogonal axes. The gyroscope is configured to sense angular velocity—e.g., a vector of rotational velocities about three, mutually orthogonal axes. The magnetometer optionally can be used to detect and correct sensor drift within the electronic gyroscope and/or accelerometer. Operationally, an electronic gyroscope is also an acceleration sensor, because of the relation between angular velocity and angular acceleration. The combined output of an IMU may be referred to as a six degrees-of-freedom (6 DOF) measurement.

Generally speaking, the output of the linear accelerometer varies in dependence on the linear acceleration of the electronic device, thereby resolving and quantifying translational movement. The output of the electronic gyroscope varies in dependence on the rotational velocity of the electronic device, thereby resolving and quantifying rotational movement. In some examples, the output of the movement sensor is subjected to a sensor-fusion process, combining linear-accelerometer, electronic-gyroscope, and magnetometer outputs to reveal and quantify device movements of particular relevance to the methods herein. Despite the practical advantages of IMU-based movement sensing, other components of electronic device 358 can be used to sense movement, alternatively or in addition. For instance, camera 166 of FIG. 1 may be configured to acquire video which is analyzed in the electronic device for indications of device movement. Such indications may include discovery of consecutive frames of video related by invariant affine transformation, for example.

Optionally, electronic device 302 may include a use-condition sensor 366 configured to provide output that varies in dependence on a use condition of the electronic device. The function and configuration of the use-condition sensor are not particularly limited. In some examples the use-condition sensor may comprise software that polls the operating system of the electronic device to determine whether a soft keyboard and/or speech-to-text interface is active. In a hinged electronic device the use-condition sensor may comprise a hardware sensor configured to sense the hinge angle—i.e., the opening angle of a device having a second display screen or other covering which folds over the touch sensor.

No aspect of the drawings or description should be interpreted in a limiting sense, because numerous variations, additions, and omissions are also envisaged. For instance, continuous touch-sensor calibration is presented hereinabove as technology that makes factory calibration—and non-volatile storage of a factory-calibration matrix—unnecessary in many cases. In other examples, however, factory calibration and continuous calibration may be used together, for combined benefits.

In some examples, a capacitive touch sensor may sense the touch point of a passive or active touch-screen stylus on the sensory surface. The touch point of a passive touch-screen stylus is sensed just like the user's finger, but the touch point of an active touch-screen stylus may be sensed somewhat differently. For instance, an active touch-screen stylus may be configured to inject charge into the column electrode directly beneath the touch point, instead of capacitively coupling that column electrode to any row electrode. Nevertheless, baseline coupling between row and column electrodes of the touch sensor may also affect the signal-to-noise ratio for detection of the touch point of an active stylus on the touch sensor, as certain noise-removal strategies used in connection with an active stylus rely on accurate touch estimation. Accordingly, the configurations and methods above apply analogously to that operating scenario.

As noted above, the methods herein may be tied to a computer system of one or more computing devices. Such methods and processes may be implemented as an application program or service, an application programming interface (API), a library, and/or other computer-program product.

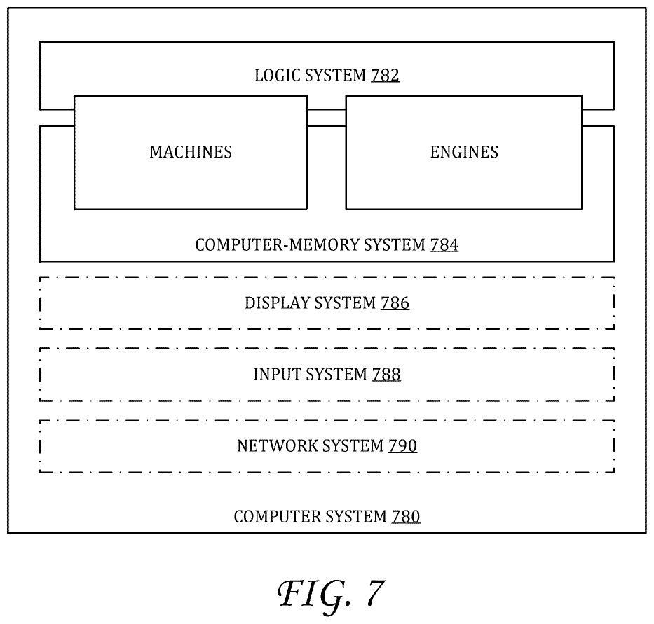

FIG. 7 provides a schematic representation of a computer system 780 configured to provide some or all of the computer system functionality disclosed herein. Computer system 780 may take the form of a personal computer, application-server computer, or any other computing device.

Computer system 780 includes a logic system 782 and a computer-memory system 784. Computer system 780 may optionally include a display system 786, an input system 788, a network system 790, and/or other systems not shown in the drawings.

Logic system 782 includes one or more physical devices configured to execute instructions. For example, the logic system may be configured to execute instructions that are part of at least one operating system (OS), application, service, and/or other program construct. The logic system may include at least one hardware processor (e.g., microprocessor, central processor, central processing unit (CPU) and/or graphics processing unit (GPU)) configured to execute software instructions. Additionally or alternatively, the logic system may include at least one hardware or firmware device configured to execute hardware or firmware instructions. A processor of the logic system may be single-core or multi-core, and the instructions executed thereon may be configured for sequential, parallel, and/or distributed processing. Individual components of the logic system optionally may be distributed among two or more separate devices, which may be remotely located and/or configured for coordinated processing. Aspects of the logic system may be virtualized and executed by remotely-accessible, networked computing devices configured in a cloud-computing configuration.

Computer-memory system 784 includes at least one physical device configured to temporarily and/or permanently hold computer system information, such as data and instructions executable by logic system 782. When the computer-memory system includes two or more devices, the devices may be collocated or remotely located. Computer-memory system 784 may include at least one volatile, nonvolatile, dynamic, static, read/write, read-only, random-access, sequential-access, location-read addressable, file-read addressable, and/or content-read addressable computer-memory device. Computer-memory system 784 may include at least one removable and/or built-in computer-memory device. When the logic system executes instructions, the state of computer-memory system 784 may be transformed—e.g., to hold different data.

Aspects of logic system 782 and computer-memory system 784 may be integrated together into one or more hardware-logic components. Any such hardware-logic component may include at least one program- or application-specific integrated circuit (PASIC/ASIC), program- or application-specific standard product (PSSP/ASSP), system-on-a-chip (SOC), or complex programmable logic device (CPLD), for example.

Logic system 782 and computer-memory system 784 may cooperate to instantiate one or more logic machines or engines. As used herein, the terms ‘machine’ and ‘engine’ each refer collectively to a combination of cooperating hardware, firmware, software, instructions, and/or any other components that provide computer system functionality. In other words, machines and engines are never abstract ideas and always have a tangible form. A machine or engine may be instantiated by a single computing device, or a machine or engine may include two or more subcomponents instantiated by two or more different computing devices. In some implementations, a machine or engine includes a local component (e.g., a software application executed by a computer system processor) cooperating with a remote component (e.g., a cloud computing service provided by a network of one or more server computer systems). The software and/or other instructions that give a particular machine or engine its functionality may optionally be saved as one or more unexecuted modules on one or more computer-memory devices.

Machines and engines (as used throughout the above description) may be implemented using any suitable combination of machine learning (ML) and artificial intelligence (AI) techniques. Non-limiting examples of techniques that may be incorporated in an implementation of one or more machines include support vector machines, multi-layer neural networks, convolutional neural networks (e.g., spatial convolutional networks for processing images and/or video, and/or any other suitable convolutional neural network configured to convolve and pool features across one or more temporal and/or spatial dimensions), recurrent neural networks (e.g., long short-term memory networks), associative memories (e.g., lookup tables, hash tables, bloom filters, neural Turing machines and/or neural random-access memory) unsupervised spatial and/or clustering methods (e.g., nearest neighbor algorithms, topological data analysis, and/or k-means clustering), and/or graphical models (e.g., (hidden) Markov models, Markov random fields, (hidden) conditional random fields, and/or AI knowledge bases)).

When included, display system 786 may be used to present a visual representation of data held by computer-memory system 784. The visual representation may take the form of a graphical user interface (GUI) in some examples. The display system may include one or more display devices utilizing virtually any type of technology. In some implementations, display system may include one or more virtual-, augmented-, or mixed reality displays.

When included, input system 788 may comprise or interface with one or more input devices. An input device may include a sensor device or a user input device. Examples of user input devices include a keyboard, mouse, or touch screen.

When included, network system 790 may be configured to communicatively couple computer system 780 with one or more other computer systems. The network system may include wired and/or wireless communication devices compatible with one or more different communication protocols. The network system may be configured for communication via personal-, local- and/or wide-area networks.

In conclusion, one aspect of this disclosure is directed to a method for calibrated touch sensing on an electronic device. The method comprises: (a) scanning a series of driven electrodes of a touch sensor while recording signal from a series of sensory electrodes of the touch sensor; (b) storing the signal in a signal matrix having a row corresponding to each row of a calibration matrix and a column corresponding to each column of the calibration matrix; (c) for each element in the signal matrix that is lower than a predetermined threshold, adjusting a corresponding element in the calibration matrix based at least partly on a value of the element in the signal matrix and on a value of the corresponding element in the calibration matrix; (d) for each element in the signal matrix that is above the predetermined threshold, estimating the corresponding element in the calibration matrix based at least partly on one or more elements neighboring the corresponding element in the calibration matrix; and (e) returning a calibrated signal value based at least partly on the value of an element in the signal matrix and of a corresponding element in the calibration matrix.

In some implementations the method further comprises initializing the calibration matrix. In some implementations adjusting the corresponding element comprises replacing the value of the corresponding element Cᵢⱼ by a value A×Cᵢⱼ+(1−A)×Hᵢⱼ, where Hᵢⱼ is the value of the element in the signal matrix and A is a predetermined parameter value between 0 and 1. In some implementations adjusting the corresponding element, estimating the corresponding element, and/or returning the calibrated signal value comprises application of a machine-learning model. In some implementations the machine-learning model is a neural network. In some implementations the machine-learning model is trained to map co-ordinate elements Hᵢⱼ and Cᵢⱼ to a calibrated signal value Sᵢⱼ by processing training data comprising benchmark Hᵢⱼ and Cᵢⱼ and corresponding, ground-truth Sᵢⱼ, where Hᵢⱼ is an element of the signal matrix, and Cᵢⱼ is a corresponding element of the calibration matrix. In some implementations the machine-learning model is configured to process non-touch sensor data from the electronic device. In some implementations estimating the corresponding element comprises interpolation, extrapolation, and/or model fitting. In some implementations the method further comprises attaching an uncertainty classification to each element in the signal matrix that is above the predetermined threshold. In some implementations the one or elements neighboring the element in the signal matrix are elements to which no uncertainty classification is attached. In some implementations the method further comprises locating and correcting an anomalous value of one or more elements in the calibration matrix.

Another aspect of this disclosure relates to an electronic device comprising a touch sensor. The touch sensor has a series of driven electrodes, a series of sensory electrodes, and a digitizer. The digitizer is configured to: (a) scan the series of driven electrodes while recording signal from the series of sensory electrodes; (b) store the signal in a signal matrix having a row corresponding to each row of a calibration matrix and a column corresponding to each column of the calibration matrix; (c) for each element in the signal matrix that is lower than a predetermined threshold, adjusting a corresponding element in the calibration matrix based at least partly on a value of the element in the signal matrix and on a value of the corresponding element in the calibration matrix; (d) for each element in the signal matrix that is above the predetermined threshold, estimating the corresponding element in the calibration matrix based at least partly on one or more elements neighboring the corresponding element in the calibration matrix; and (e) return a calibrated signal value based at least partly on the value of an element in the signal matrix and of a corresponding element in the calibration matrix.

In some implementations the digitizer is further configured to initialize the calibration matrix. In some implementations adjusting the corresponding element comprises replacing the value of the corresponding element Cᵢⱼ by a value A×Cᵢⱼ+(1−A)×Hᵢⱼ, where Hᵢⱼ is the value of the element in the signal matrix and A is a predetermined parameter value between 0 and 1. In some implementations adjusting the corresponding element, estimating the corresponding element, and/or returning the calibrated signal value comprises application of a machine-learning model. In some implementations the machine-learning model is a neural network. In some implementations the machine-learning model is trained to map co-ordinate elements Hᵢⱼ and Cᵢⱼ to a calibrated signal value Sᵢⱼ by processing training data comprising benchmark Hᵢⱼ and Cᵢⱼ and corresponding, ground-truth Sᵢⱼ, where Hᵢⱼ is an element of the signal matrix, and Cᵢⱼ is a corresponding element of the calibration matrix. In some implementations the machine-learning model is configured to process non-touch sensor data from the electronic device. In some implementations estimating the corresponding element comprises interpolation, extrapolation, and/or model fitting.

Another aspect of this disclosure is directed to a method for calibrated touch sensing on an electronic device. The method comprises: (a) scanning a series of driven electrodes of a touch sensor while recording signal from a series of sensory electrodes of the touch sensor; (b) storing the signal in a signal matrix having a row corresponding to each row of a calibration matrix and a column corresponding to each column of the calibration matrix; (c) for each element in the signal matrix that is lower than a predetermined threshold, adjusting a corresponding element in the calibration matrix based at least partly on a value of the element in the signal matrix and on a value of the corresponding element in the calibration matrix; (d) for each element in the signal matrix that is above the predetermined threshold, estimating the corresponding element in the calibration matrix based at least partly on one or more elements neighboring the corresponding element in the calibration matrix; (e) returning a calibrated signal value based at least partly on the value of an element in the signal matrix and of a corresponding element in the calibration matrix; and (f) locating and correcting an anomalous value of one or more elements in the calibration matrix.

This disclosure is presented by way of example and with reference to the attached drawing figures. Components, process steps, and other elements that may be substantially the same in one or more of the figures are identified coordinately and described with minimal repetition. It will be noted, however, that elements identified coordinately may also differ to some degree. It will be further noted that the figures are schematic and generally not drawn to scale. Rather, the various drawing scales, aspect ratios, and numbers of components shown in the figures may be purposely distorted to make certain features or relationships easier to see.

It will be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated and/or described may be performed in the sequence illustrated and/or described, in other sequences, in parallel, or omitted. Likewise, the order of the above-described processes may be changed. In that spirit, the phrase ‘based at least partly on’ is intended to remind the reader that the functional and/or conditional logic illustrated herein neither requires nor excludes suitable additional logic, executing in combination with the illustrated logic, to provide additional benefits.

The subject matter of the present disclosure includes all novel and non-obvious combinations and sub-combinations of the various processes, systems and configurations, and other features, functions, acts, and/or properties disclosed herein, as well as any and all equivalents thereof.

1. A method for calibrated touch sensing on an electronic device, the method comprising:
scanning a series of driven electrodes of a touch sensor while recording signal from a series of sensory electrodes of the touch sensor;
storing the signal in a signal matrix having a row corresponding to each row of a calibration matrix and a column corresponding to each column of the calibration matrix;
for each element in the signal matrix that is lower than a predetermined threshold, adjusting a corresponding element in the calibration matrix based at least on a value of the element in the signal matrix and on a value of the corresponding element in the calibration matrix;
for each element in the signal matrix that is above the predetermined threshold, estimating the corresponding element in the calibration matrix based at least on one or more elements neighboring the corresponding element in the calibration matrix; and
returning a calibrated signal value based at least on the value of an element in the signal matrix and of a corresponding element in the calibration matrix.

2. The method of claim 1 further comprising initializing the calibration matrix.

3. The method of claim 1 wherein adjusting the corresponding element comprises replacing the value of the corresponding element Cᵢⱼ by a value A×Cᵢⱼ+(1−A)×Hᵢⱼ, where Hᵢⱼ is the value of the element in the signal matrix and A is a predetermined parameter value between 0 and 1.

4. The method of claim 1 wherein adjusting the corresponding element, estimating the corresponding element, and/or returning the calibrated signal value comprises application of a machine-learning model.

5. The method of claim 4 wherein the machine-learning model is a neural network.

6. The method of claim 4 wherein the machine-learning model is trained to map co-ordinate elements Hᵢⱼ and Cᵢⱼ to a calibrated signal value Sᵢⱼ by processing training data comprising benchmark Hᵢⱼ and Cᵢⱼ and corresponding, ground-truth Sᵢⱼ, where Hᵢⱼ is an element of the signal matrix, and Cᵢⱼ is a corresponding element of the calibration matrix.

7. The method of claim 4 wherein the machine-learning model is configured to process non-touch sensor data from the electronic device.

8. The method of claim 1 wherein estimating the corresponding element comprises interpolation, extrapolation, and/or model fitting.

9. The method of claim 1 further comprising attaching an uncertainty classification to each element in the signal matrix that is above the predetermined threshold.

10. The method of claim 9 wherein the one or elements neighboring the element in the signal matrix are elements to which no uncertainty classification is attached.

11. The method of claim 1 further comprising locating and correcting an anomalous value of one or more elements in the calibration matrix.

12. An electronic device comprising:
a touch sensor having a series of driven electrodes, a series of sensory electrodes, and a digitizer configured to:
scan the series of driven electrodes while recording signal from the series of sensory electrodes;
store the signal in a signal matrix having a row corresponding to each row of a calibration matrix and a column corresponding to each column of the calibration matrix;
for each element in the signal matrix that is lower than a predetermined threshold, adjust a corresponding element in the calibration matrix based at least on a value of the element in the signal matrix and on a value of the corresponding element in the calibration matrix;
for each element in the signal matrix that is above the predetermined threshold, estimate the corresponding element in the calibration matrix based at least on one or more elements neighboring the corresponding element in the calibration matrix; and
return a calibrated signal value based at least on the value of an element in the signal matrix and of a corresponding element in the calibration matrix.

13. The electronic device of claim 12 wherein the digitizer is further configured to initialize the calibration matrix.

14. The electronic device of claim 12 wherein adjusting the corresponding element comprises replacing the value of the corresponding element Cᵢⱼ by a value A×Cᵢⱼ+(1−A)×Hᵢⱼ, where Hᵢⱼ is the value of the element in the signal matrix and A is a predetermined parameter value between 0 and 1.

15. The electronic device of claim 12 wherein adjusting the corresponding element, estimating the corresponding element, and/or returning the calibrated signal value comprises application of a machine-learning model.

16. The electronic device of claim 15 wherein the machine-learning model is a neural network.

17. The electronic device of claim 15 wherein the machine-learning model is trained to map co-ordinate elements Hᵢⱼ and Cᵢⱼ to a calibrated signal value Sᵢⱼ by processing training data comprising benchmark Hᵢⱼ and Cᵢⱼ and corresponding, ground-truth Sᵢⱼ, where Hᵢⱼ is an element of the signal matrix, and Cᵢⱼ is a corresponding element of the calibration matrix.

18. The electronic device of claim 15 wherein the machine-learning model is configured to process non-touch sensor data from the electronic device.

19. The electronic device of claim 12 wherein estimating the corresponding element comprises interpolation, extrapolation, and/or model fitting.

20. A method for calibrated touch sensing on an electronic device, the method comprising:
scanning a series of driven electrodes of a touch sensor while recording signal from a series of sensory electrodes of the touch sensor;
storing the signal in a signal matrix having a row corresponding to each row of a calibration matrix and a column corresponding to each column of the calibration matrix;
for each element in the signal matrix that is lower than a predetermined threshold, adjusting a corresponding element in the calibration matrix based at least on a value of the element in the signal matrix and on a value of the corresponding element in the calibration matrix;
for each element in the signal matrix that is above the predetermined threshold, estimating the corresponding element in the calibration matrix based at least on one or more elements neighboring the corresponding element in the calibration matrix;
returning a calibrated signal value based at least on the value of an element in the signal matrix and of a corresponding element in the calibration matrix; and
locating and correcting an anomalous value of one or more elements in the calibration matrix.
